(19) United States
(12) Patent Application Publication
(10) Pub. No.: US 2002/0181879 A1
(43) Pub. Date: Dec. 5, 2002

(54) Chromatic dispersion compensation and dispersion slope compensation method and apparatus

(76) Inventors: Scott Robertson Bickham, Corning, NY (US); Vitor M. Schneider, Painted Post, NY (US); David Kinney Smith, Wilmington, NC (US); James Andrew West, Painted Post, NY (US)

Correspondence Address: VOLENTINE FRANCOS, P.L.L.C., 50 Commerce Drive, Wyomissing, PA, 19610, US

(21) Appl. No.: 10/143,249

(22) Filed: May 9, 2002

Related U.S. Application Data
(63) Continuation-in-part of application No. 09/983,771, filed on Oct. 25, 2001.
(60) Provisional application No. 60/295,108, filed on May 31, 2001.

(51) Int. Cl. G02B 6/26; G02B 6/16; G02B 6/28

(52) U.S. Cl. 385/50; 385/27; 385/123; 385/24

(57) ABSTRACT

According to an exemplary embodiment of the present invention, an optical apparatus compensates for chromatic dispersion and/or dispersion in an optical signal includes a plurality of serially coupled optical waveguides each of which introduces chromatic dispersion and/or dispersion slope to the optical signal that traverses the optical waveguides. The resultant magnitude and sign of the chromatic dispersion and/or dispersion slope introduced into the optical signal is a combination of the chromatic dispersion and/or dispersion slope from the plurality of optical waveguides

### CROSS-REFERENCE TO RELATED APPLICATIONS

The present application is a continuation-in-part of U.S. patent application Ser. No. 09/983,771, filed Oct. 25, 2001, to V. Schneider, et. al, and entitled “Dynamic Chromatic Dispersion Control Apparatus Using Coupled Waveguide Structures.” The present application also claims priority under 35 USC §119(e) from U.S. Provisional Application No. 60/295,108 entitled “The Use of n-Series Solution for Simultaneous Dispersion and Dispersion Slope Compensation Over a Wide Range of Wavelengths,” filed May 31, 2001. The disclosures of the above captioned parent and provisional applications are specifically incorporated herein by reference and for all purposes.

### FIELD OF THE INVENTION

The present invention relates in general to optical communication systems, and in particular to a method and apparatus for compensating for chromatic dispersion and dispersion slope in an optical signal.

### BACKGROUND OF THE INVENTION

Optical transmission systems, including optical fiber communication systems, have become an attractive alternative for carrying voice and data at high speeds. In optical transmission systems, waveform degradation due to chromatic dispersion (CD) in the optical transmission medium can be problematic, particularly as transmission speeds continue to increase.

Chromatic dispersion in optical signals results from the fact that in transmission media such as glass optical waveguides, the higher the frequency of the optical signal, the greater is the refractive index. As such, higher frequency components of optical signals will “slow down,” and contrastingly, lower frequency signals will “speed-up.”

In single mode optical fiber, chromatic dispersion results from the interplay of two underlying effects, material dispersion and waveguide dispersion. Material dispersion results from the non-linear dependence of the refractive index upon wavelength, and the corresponding group velocity of the material, which is illustratively doped silica. Waveguide dispersion results from the wavelength dependent relationships of the group velocity to the core diameter and the difference in the index of refraction between the core and the cladding.

In addition to the above referenced sources of CD, impurities in the waveguide material, mechanical stress and strain, and temperature effects can also affect the index of refraction, further adding to the ill effects of chromatic dispersion.

In digital optical communications, where the optical signal is ideally a square wave, bit spreading due to chromatic dispersion can be particularly problematic. To this end, as the “fast frequencies” in the signal slow down and the “slow frequencies” in the signal speed up as a result of chromatic dispersion, the shape of the waveform can be substantially impacted. The effects of this type of dispersion are a spreading of the original pulse in time, causing it to overflow into the time slot that has already been allotted to another bit. When the overflow becomes excessive, intersymbol interference (ISI) may result. ISI may result in an increase in the bit-error rate to unacceptable levels.

As can be appreciated, control of the total chromatic dispersion of transmission paths in an optical communication system is critical to the design and construction of long haul, and high-speed communications systems. To achieve this control, it is necessary to reduce the total dispersion to a point where its contribution to the bit-error rate of the signal is acceptable. In commonly used dense wavelength division multiplexed (DWDM) optical communications systems, there may be 40 wavelength channels or more, with the center wavelength of each channel being separated from its adjacent channels by approximately 0.8 nm to approximately 1.0 nm. For example, a 40-channel system could have center wavelengths in the range of approximately 1530 nm to approximately 1570 nm. As can be appreciated, compensating for chromatic dispersion in such a system can be difficult.

Accordingly, what is needed is a method and apparatus for compensating for chromatic dispersion and/or dispersion slope in an optical signal that overcomes at least the drawbacks of the prior art described above.

### SUMMARY OF THE INVENTION

According to an exemplary embodiment of the present invention, an optical apparatus compensates for chromatic dispersion and/or dispersion slope in an optical signal includes a plurality of serially coupled optical waveguides each of which introduces chromatic dispersion and/or dispersion slope to the optical signal that traverses the optical waveguides. The resultant magnitude and sign of the chromatic dispersion and/or dispersion slope introduced into the optical signal is a combination of the chromatic dispersion and/or dispersion slope from the plurality of optical waveguides.

According to another exemplary embodiment of the present invention, a method for compensating for chromatic dispersion and/or dispersion slope in an optical signal comprises providing a plurality of serially coupled optical fibers chosen to have a net desired chromatic dispersion and/or dispersion slope compensating effect when disposed in a particular order.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion. Moreover, like reference numerals represent like elements throughout.

FIG. 1 is a schematic representation of an optical apparatus in accordance with an exemplary embodiment of the present invention.

FIG. 2 is a graphical representation of the chromatic dispersion versus wavelength for an illustrative dispersion compensating optical fiber used in an optical apparatus in accordance with an exemplary embodiment of the present invention.

FIG. 3 is a graphical representation of the slope of the chromatic dispersion versus wavelength for an illustrative dispersion compensating optical fiber used in an optical apparatus of an exemplary embodiment of the present invention.

FIG. 4 is graphical representation of the chromatic dispersion versus wavelength for a representative dispersion compensating fiber in accordance with an exemplary embodiment of the present invention.

FIG. 5 is a graphical representation of the nominal dispersion characteristics of three optical fibers in accordance with an exemplary embodiment of the present invention.

FIGS. 6(a) and 6(b) are graphical representations of the dispersion versus wavelength of selectively serially coupled optical waveguides fibers in accordance with exemplary embodiments of the present invention.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art having had the benefit of the present disclosure, that the present invention may be practiced in other embodiments that depart from the specific details disclosed herein. Moreover, descriptions of well-known devices, methods and materials may be omitted so as to not obscure the description of the present invention.

Briefly, the present invention relates to an optical apparatus and its method of use, which compensates for chromatic dispersion and dispersion slope in an optical signal over a wavelength band. In an exemplary embodiment, the optical apparatus includes an integer number (n) of serially connected dispersion compensating optical waveguides. Each of the dispersion compensating waveguides is chosen for its particular dispersion characteristic at a particular portion of a wavelength band over which the optical apparatus is chosen to operate. Moreover, because dispersion is normally measured in units of ps/nm-km, an appropriate length of each of the serially coupled dispersion compensating optical waveguides is chosen to exact a desired amount of dispersion compensation at each portion of the wavelength band.

Accordingly, as will become more clear as the present description proceeds, by the appropriate selection of each dispersion compensating optical waveguide for its dispersion characteristic at a particular portion of the wavelength band over which the optical apparatus operates; and the appropriate selection of the length of each waveguide to exact a desired amount of dispersion compensation, a dispersion characteristic may be synthesized for optical apparatus in accordance with an exemplary embodiment of the present invention. This synthesized dispersion characteristic may be chosen to nullify the chromatic dispersion of an optical signal, the dispersion slope of an optical signal, or both. Additionally, or alternatively, this synthesized dispersion characteristic may be chosen to yield a net amount of positive or negative chromatic dispersion in an optical signal, as well as a net positive or negative dispersion slope in the optical signal.

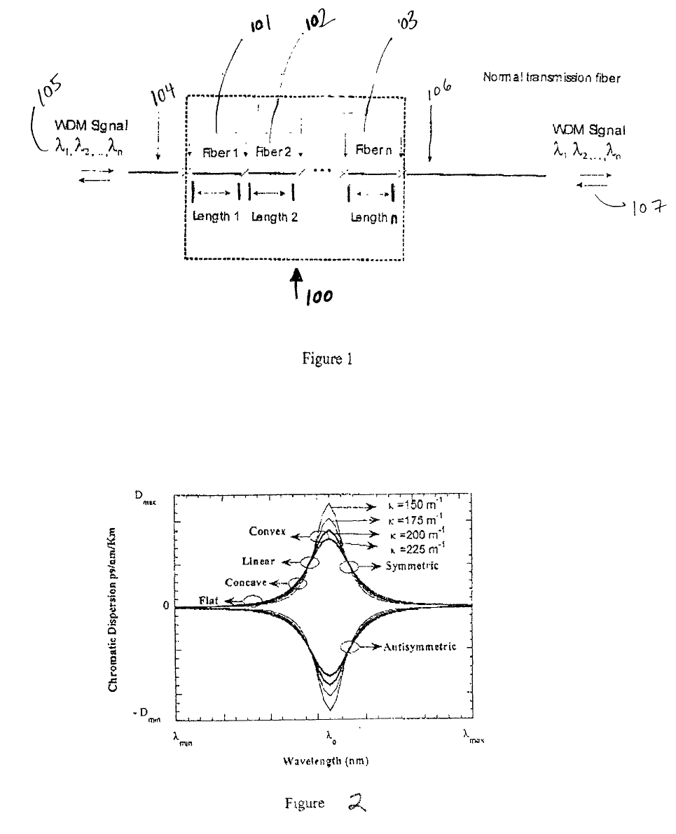

Turning to FIG. 1, an optical apparatus 100 in accordance with an exemplary embodiment of the present invention includes n-dispersion compensating waveguides optically coupled in series via known optical coupling techniques. Illustratively, a first dispersion waveguide 101 is serially coupled to a second dispersion compensating waveguide 102, etc., with an (n−1)^{th} dispersion compensating waveguide (not shown) coupled to an n^{th} dispersion compensating waveguide 103 completing the optical apparatus 100. For purposes of illustration and not limitation, the number of dispersion compensating waveguides (n) is illustratively greater than or equal to (n≧2) two and less than twenty (n<20).

An input optical signal 105 traverses an input optical waveguide 104 of an optical communications system. The input optical signal 105 is illustratively a WDM or DWDM signal having a plurality of optical channels; each channel having a prescribed center wavelength, channel bandwidth, and each channel being spaced from its adjacent channels by a prescribed channel spacing.

As mentioned above, various sources of chromatic dispersion contribute to the overall chromatic dispersion present in the input optical signal 105. Moreover, the chromatic dispersion can vary over wavelength, contributing to dispersion slope, which can have deleterious effects on the signal quality. The resultant chromatic dispersion present in the optical signal from the various sources of chromatic dispersion has a particular dispersion ‘shape’ or curvature (often referred to as the dispersion characteristic) over a particular wavelength band (e.g. the wavelength band of the multiplexed input optical signal 105).

For reasons which will become more clear as the present description continues, each of the dispersion compensating optical waveguides of the optical apparatus 100 is chosen for its chromatic dispersion characteristics and/or its dispersion slope characteristics over a chosen wavelength band. The resultant chromatic dispersion and dispersion slope characteristics of the serial chromatic dispersion compensating waveguides is illustratively nullifies the dispersion and/or dispersion slope present in an optical signal. To wit, the optical apparatus 100 is designed to have a dispersion curvature over the wavelength band of the input optical signal 105 which is at every point of the wavelength band equal in magnitude, but opposite in sign to the dispersion curvature that adversely impacts the input optical signal 105.

Accordingly, in the present illustrative embodiment, the dispersion and/or dispersion slope present in the input optical signal 105 has been nullified so that the output signal 107 of the output optical fiber 106 is substantially free of chromatic dispersion and/or dispersion slope. However, as mentioned previously, the optical apparatus 100 may be used to introduce chromatic dispersion and/or dispersion slope to the input optical signal 105 so that the output optical signal 107 has a finite (positive or negative) net chromatic dispersion, dispersion slope, or both. Moreover, it is noted that over the selected wavelength band, the net chromatic dispersion may be positive over one or more wavelength sub-bands (of the wavelength band), negative over one or more wavelength sub-bands and zero over one or more wavelength sub-bands. Likewise, the dispersion slope dispersion may be positive over one or more wavelength sub-bands, negative over one or more wavelength sub-bands and zero over one or more wavelength sub-bands.

The optical apparatus 100 may be used in a variety of applications. To this end, the optical apparatus 100 may be an integral part of the transmission fibers of the optical communication system, and/or the apparatus 100 may be a stand-alone module comprising a single optical apparatus or a plurality of such optical apparati connected in series. Moreover, the n-dispersion compensating waveguides are illustratively dispersion compensating optical fibers of the types described below.

For purposes of illustration and not limitation, the optical apparatus 100 could be used as a dispersion compensating module used in the optical apparatus as shown and described in U.S. patent application Ser. No. 09/983,769, to Schneider, et al., and entitled “Chromatic Dispersion Control Method and Apparatus.” The invention of the above referenced patent application is assigned to the assignee of the present invention and is specifically incorporated herein by reference.

The n-serially coupled dispersion compensating optical waveguides of the optical apparatus 100 may be chosen from the various types of dispersion compensating optical waveguides described presently. It is noted that these dispersion compensating optical waveguides are intended to be illustrative, and in no way limiting of the present invention. Moreover, it is noted that the n-serially coupled compensating optical waveguides may all be one type of dispersion compensating waveguide; or a combination of various types of dispersion compensating optical waveguides, chosen for their particular chromatic dispersion and/or dispersion slope characteristic over a particular wavelength band.

Examples of dispersion compensating optical wavguide that may be used for some or all of the n-serially dispersion compensating optical waveguides of the optical apparatus 100 are selected lengths of dispersion compensating optical fibers which are described in U.S. Pat. Nos. 5,361,319 and 5,999,679 to Antos, et al, the disclosures of which are specifically incorporated herein by reference. Moreover, the dispersion compensating optical waveguides may be a plurality of dispersion compensating gratings such as fiber Bragg gratings (FBG), which may be chirped linearly and/or non-linearly, chirped. Of course, in keeping with the present invention, each individual dispersion compensating optical waveguide of the optical apparatus 100 is chosen to contribute a certain portion of the overall curvature of the dispersion of the optical apparatus over a desired wavelength range so that the output optical signal 107 has a desired magnitude of dispersion (positive, negative or zero, or a combination thereof) and dispersion slope (also positive, negative or zero, or a combination thereof) at each point of its wavelength band.

In addition to the dispersion compensating waveguides described thus far, coupled waveguides may be used as some or all of the n-serially coupled dispersion compensating optical waveguides in accordance with the presently described exemplary embodiment. Coupled waveguides may comprise a central core and a circumferential ring(s) at some distance from the core. The core and the ring(s) have indices of refraction that are greater than the cladding material of the waveguide. These same profiles may or may not have depressed index regions relative to the index of refraction of the cladding material inside and/or outside the ring.

In coupled waveguide structures, when light is coupled into the core of the waveguide, it can be coupled to the ring under certain conditions, and in a variety of ways. This type of coupling is generally known as directional coupling. Moreover, the eigenmodes of such a coupled waveguide system are referred to as supermodes. Further details of coupled waveguides and supermodes may be found for example in “Optical Electronics” (3^{rd} Edition) by Amnon Yariv, pages 437-447; and in “Dielectric Laser and Photonic Integrated Circuits”, by Coldren and Corzine, pages 282-287. The disclosure of the referenced materials is specifically incorporated by reference herein and for all purposes.

The dispersion characteristic of the fundamental and first order harmonic supermodes may be used to effect dispersion compensation in accordance with an exemplary embodiment of the present invention.

The coupling between the ring and core causes the dispersion of such coupled optical waveguides to be governed mainly by the waveguide dispersion of the coupled system. Specifically, it can be shown that the group velocity dispersion (chromatic dispersion) may be approximated by:

$${GVD}_{{super}_{svm ( + ) asvm ( - )}} = {D}_{0} \pm \frac{1}{4 κ} {{( \frac{1}{{v}_{1}} - \frac{1}{{v}_{2}} )}^{2} [ \frac{{( ω - {ω}_{0} )}^{2}}{4 {κ}^{2}} {( \frac{1}{{v}_{2}} - \frac{1}{{v}_{1}} )}^{2} + 1 ]}^{- 3 / 2} \qquad ( 1 )$$

where GVD is the group velocity dispersion of the symmetric and asymmetric supermodes; v₁ and v₂ are the group velocities of the first and second waveguides, respectively, at the angular frequency ω₀ (that corresponds to a wavelength λₒ); and κ is the coupling constant of the guides.

A few points in connection with equation (1) are at worthy of discussion presently. First, the coupling coefficient, κ, can be shown to be proportional to the refractive index profile of the coupled waveguide structure. Moreover, when ω=ω₀ (which corresponds to the case when λ=λₒ), it can be shown that the optical power is coupled with maximum efficiency between the two waveguides. This is known as the resonance condition of the supermode, and occurs when there is no phase velocity differential between the individual waveguide eigenmode velocities. At resonance, propagated mode experiences a maximum shift in its group velocity, resulting in a relative maximum in the chromatic dispersion.

It is noted that the index of refraction profile of this coupled waveguide structure may be dynamically manipulated. This enables the dispersion characteristic of the coupled waveguide structure to be selectively varied. Alternatively, the index of refraction profile may be substantially static, with the selected parameters of eqn. 1 remaining fixed.

Turning to FIG. 2, an example of a typical graph of the chromatic dispersion versus wavelength for a variety of coupled waveguide structures having different coupling constants, κ, is shown. At a particular wavelength, λ₀, the chromatic dispersion reaches a maximum peak 201 for the symmetric eigenmode (fundamental mode), and a minimum peak 202 for the asymmetric eigenmode (first order harmonic).

As can be appreciated from a review of FIG. 2, the absolute value of the chromatic dispersion (positive or negative dispersion) is also dependent upon the coupling coefficient κ. Moreover, from a review of equation (1), a change in κ and the group velocities v₁ and v₂ will result in a change in the values of the group velocity dispersion around the wavelength λ₀. It follows that a small change in the index of refraction of the core, ring or cladding (or a combination thereof) can lead to significant changes in the chromatic dispersion. Changes in the values the dispersion due to changes in the refractive index profile are also associated with shifts in the resonant wavelength, λ₀. As referenced above, for each of the n-serially coupled optical waveguides of an exemplary embodiment, the choice of parameters such as the index of refraction of the core, ring or cladding may be set for a desired dispersion curve; may be selectively varied to achieve a desired dispersion curve; or a combination of these techniques may be used.

All these effects that change the dispersion values and shift the resonance are coupled and cannot be disassociated when the profile is changed. In particular, changes in the index of refraction can result in a shift of the curves along the abscissa (wavelength axis) of the graph shown in FIG. 2, as well as the shape of the dispersion. This enables tuning of the dispersion characteristic and, thereby, the chromatic dispersion and dispersion slope.

By using coupled waveguides for one or more of the n-serially coupled dispersion compensating waveguides of the present invention, selection of a desired chromatic dispersion characteristic with a particular dispersion slope may be achieved. Alternatively, use of coupled waveguide structures for one or more of the n-serial dispersion compensating waveguides of the present invention enables tuning of the chromatic dispersion and/or dispersion slope. This tuning may be used to dynamically change the net dispersion and/or dispersion slope of the output optical signal 107.

Further details of coupled waveguides structures as well as dynamic dispersion and/or dispersion slope compensation using coupled waveguide structures may be found in the parent application to Schneider, et al.

As shown in FIG. 2, the dispersion characteristics of the coupled waveguide dispersion compensating waveguides can be approximately flat, linear, concave or convex in shape as is indicated. Moreover, as will become more clear as the present description continues by suitable selection of variables from eqn. (1) (e.g. coupling coefficient κ) for a particular coupled fiber, a particular curvature may be selected over a particular wavelength range. This enables the synthesis of the resultant dispersion characteristic of the n-serially coupled dispersion compensating optical waveguides of the optical apparatus 100.

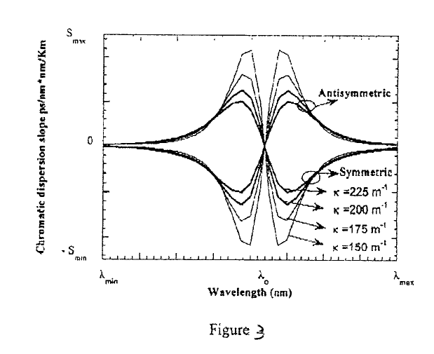

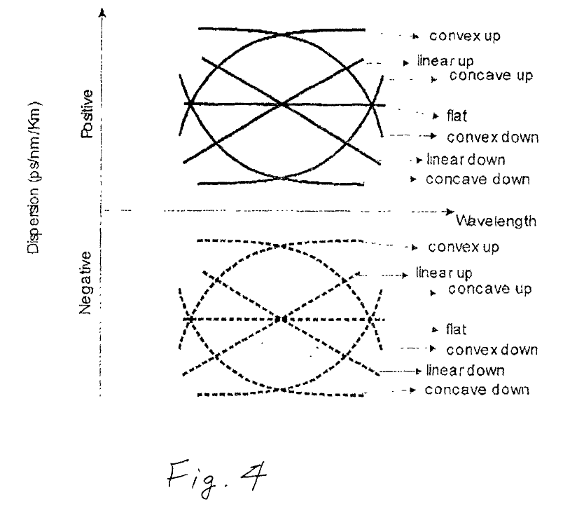

FIG. 3 shows examples of the dispersion slope (change in dispersion per unit change in wavelength) over a wavelength band with coupled waveguide structures having various coupling coefficients.

From the above description, it is appreciated that a variety of dispersion curves are available depending on the selection of the serially coupled dispersion compensating waveguides. The synthesis of a desired dispersion curve to exact a desired amount of dispersion and/or dispersion slope compensation is readily achieved by the selection of certain dispersion compensating waveguides and their respective lengths. An exemplary embodiment incorporating illustrative serially coupled dispersion compensating waveguides is described presently.

FIG. 4 shows examples of dispersion characteristics that may be achieved using serially connected coupled waveguide structures (e.g. the dispersion compensating fibers described above, and in the parent application) in accordance with an exemplary embodiment. To this end, by coupling two or more coupled waveguides in series, a multiformity of dispersion characteristics may be realized over a particular wavelength bands. These dispersion characteristics are illustratively linear of positive slope, linear of negative slope, flat, concave up, concave down, convex up and convex down. (It is noted that high positive dispersion values and characteristics may normally require the excitation and propagation of higher order modes in the coupled waveguide structure.) Moreover, each of these curves may be positive or negative; and it is possible to synthesize a dispersion curve that is positive over a particular portion of the wavelength band, negative over another, and zero over a transition region therebetween. Again, the resultant dispersion characteristic of the n-serially coupled dispersion compensating waveguides depends on the number, the dispersion characteristics and the lengths of the dispersion compensation compensating dispersion compensating waveguides (in this fibers) chosen.

In addition, the dispersion characteristic over the wavelength band may be synthesized to have one shape over one portion of the wavelength band, and other shapes over other portions of the wavelength band. Finally, it is noted that the slope of the linear curves, the radii of curvature of the convex/concave curves and the magnitude of the flat curves are merely illustrative. Each may be increased/decreased by the suitable selection of the coupled waveguide structures and the choice of their respective lengths.

FIG. 5 shows the chromatic dispersion versus wavelength for three illustrative dispersion compensating optical fibers (fibers A, B and C) having particular dispersion and dispersion slope characteristics.

As can be appreciated from a review of FIG. 5, fibers A, B and C have different nominal dispersions per Km. As such, the association of these fibers with different lengths would lead to different results.

Fiber A has a negative dispersion characteristic with a negative concave slope over the chosen wavelength band. Fiber B has a positive dispersion characteristic with a slight positive linear slope, and Fiber C has a negative dispersion characteristic with no slope. Again it is noted that the association of these fibers with different lengths would produce completely different results. One can use this association to match dispersion values and dispersion slope values at a wider range of wavelengths.

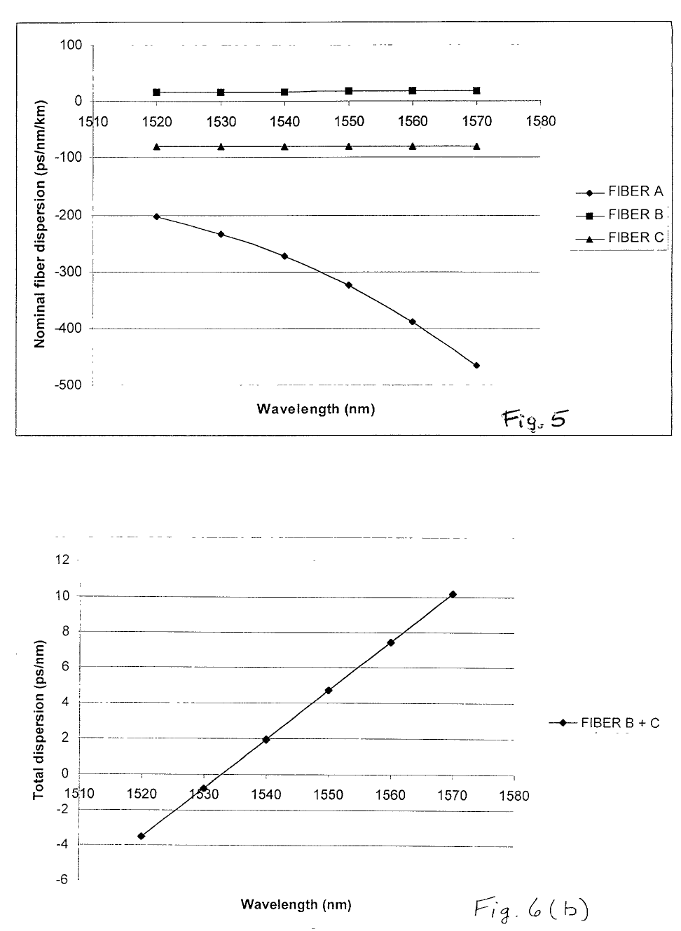

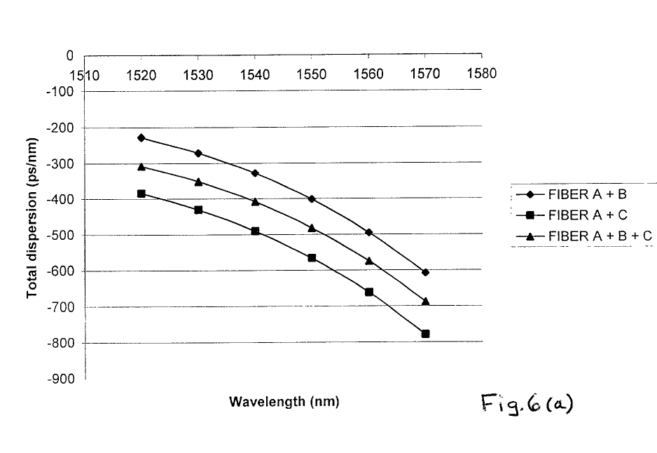

For example, the selective serial connection of 1.5 Km of fiber A, 0.5 Km of fiber B and 1 Km of fiber C leads to the resultant dispersion curves shown in FIG. 6(a). As can be appreciated from a review of FIG. 6(a), the combination of these illustrative lengths of the illustrative dispersion compensating fibers each having different dispersion lengths can lead to a different value of dispersion and dispersion slope at each point along the curve. In the present exemplary embodiment, each selective serial connection of the chosen lengths of fibers A, B and C results in a dispersion characteristic having an overall negative dispersion across this wavelength band, and a negative concave dispersion slope.

It is emphasized that the dispersion characteristics shown in FIG. 5 are merely illustrative of the possible combinations that can be realized using the three exemplary optical fibers. For example, FIG. 6(b) shows dispersion characteristic realized by the serial coupling of 5 Km of fiber B, and 1 Km of fiber C. In this illustrative embodiment, the dispersion characteristic exhibits positive dispersion and dispersion slope over the illustrative wavelength band.

It is also emphasized that the examples described in connection with FIGS. 6(a) and 6(b) are merely illustrative of the invention of the present disclosure. To be sure, other dispersion compensating optical waveguides of other lengths may be chosen to achieve a variety of results. The choice of the particular lengths of particular waveguides having desired dispersion and dispersion slope characteristics, when coupled serially, enables a wide variety of dispersion characteristics over a selected wavelength range.

The invention having been described in detail in connection through a discussion of exemplary embodiments, it is clear that modifications of the invention will be apparent to one having ordinary skill in the art having had the benefit of the present disclosure. Such modifications and variations are included in the scope of the appended claims.

1. An optical apparatus which compensates for chromatic dispersion and/or dispersion slope, comprising:
a plurality of serially coupled optical waveguides each of which introduces chromatic dispersion and/or dispersion slope to an optical signal that traverses the optical waveguides.

2. An optical apparatus as recited in claim 1, wherein said serially coupled optical waveguides are chosen from the group consisting essentially of: coupled waveguide structures; dispersion compensating optical fiber; and fiber Bragg gratings.

3. An optical apparatus as recited in claim 1, wherein the optical apparatus has a dispersion characteristic over a selected wavelength range that is a resultant of respective dispersion characteristics of said plurality of serially coupled optical waveguides.

4. An optical apparatus as recited in claim 3, wherein said resultant is equal in magnitude but opposite in sign over said selected wavelength range to a dispersion characteristic of an optical communication system to which the optical apparatus is coupled.

5. An optical apparatus as recited in claim 1, wherein each of said plurality of optical waveguides has a dispersion characteristic chosen so as to have, in combination, a desired net chromatic dispersion and/or dispersion slope compensation effect.

6. An optical apparatus as recited in claim 5, wherein, over a selected wavelength range, said net chromatic dispersion and/or dispersion slope compensation effect nullifies chromatic dispersion and/or dispersion slope; adds positive or negative dispersion and or dispersion slope; or a combination thereof.

7. An optical apparatus as recited in claim 1, wherein said plurality is greater than or equal to two and less than twenty.

8. An optical apparatus as recited in claim 1, wherein at least one of said plurality of serially coupled optical waveguides is tunable to a particular dispersion characteristic over a particular wavelength range.

9. An optical apparatus as recited in claim 8, wherein said at least one serially coupled waveguide is a coupled waveguide.

10. An optical apparatus as recited in claim 9, wherein said coupled waveguide has a tunable dispersion resonance wavelength and a tunable dispersion slope.

11. An optical apparatus as recited in claim 1, wherein at least one of said plurality of optical waveguides supports a fundamental mode.

12. An optical apparatus as recited in claim 1, wherein at least one of said plurality of optical waveguides supports at least one higher order mode.

13. An optical apparatus as recited in claim 1, wherein at least one of the optical apparati are disposed in an optical communications link.

14. An optical apparatus as recited in claim 5, wherein each of said plurality of optical waveguides has a selected length.

15. A method for compensating for chromatic dispersion and/or dispersion slope in an optical signal, the method comprising:
providing a plurality of serially coupled optical fibers chosen to have a net desired chromatic dispersion and/or dispersion slope compensating effect when disposed in a particular order.

16. A method as recited in claim 15, wherein each of said plurality of optical waveguides has a selected length.

17. A method as recited in claim 15, said serially coupled optical waveguides are chosen from the group consisting essentially of: coupled waveguide structures; dispersion compensating optical fiber; and fiber Bragg gratings.

18. A method as recited in claim 15, wherein the method further comprises providing at least one set of said serially coupled waveguides in an optical communications link.

19. A method as recited in claim 15, wherein said serially coupled optical waveguides effect a dispersion characteristic over a selected wavelength range that is a resultant of respective dispersion characteristics of said plurality of serially coupled optical waveguides.

20. A method as recited in claim 19, wherein said resultant is equal in magnitude but opposite in sign over said selected wavelength range of a dispersion characteristic to an optical communication system to which the optical apparatus is coupled.

24. A method as recited in claim 15, wherein each of said plurality of optical waveguides has a dispersion characteristic chosen so as to have, in combination, a desired net chromatic dispersion and/or dispersion slope compensation effect.

25. A method as recited in claim 24, wherein, over a selected wavelength range, said net chromatic dispersion and/or dispersion slope compensation effect nullifies chromatic dispersion and/or dispersion slope; adds positive or negative dispersion and or dispersion slope; or a combination thereof.

26. A method as recited in claim 15, wherein at least one of said plurality of serially coupled optical waveguides is tunable to a particular dispersion characteristic over a particular wavelength range.

27. A method as recited in claim 15, wherein said plurality is greater than or equal to (n≧2) and less than twenty (n<20).

28. A method as recited in claim 26, wherein said at least one serially coupled waveguide is a coupled waveguide.

29. A method as recited in claim 15, wherein at least one of said plurality of optical waveguides supports a fundamental mode.

30. A method as recited in claim 15, wherein at least one of said plurality of optical waveguides supports at least one higher order mode.
